(19) United States
(12) Patent Application Publication
(10) Pub. No.: US 2018/0314047 A1
(43) Pub. Date: Nov. 1, 2018

(54) MICROSCOPE

(71) Applicant: OLYMPUS CORPORATION, Tokyo (JP)

(72) Inventor: Yoshihiro SHIMADA, Kanagawa (JP)

(73) Assignee: OLYMPUS CORPORATION, Tokyo (JP)

(21) Appl. No.: 15/946,185

(22) Filed: Apr. 5, 2018

(30) Foreign Application Priority Data
Apr. 27, 2017 (JP) 2017-088213

(51) Int. Cl. G02B 21/33; G02B 21/26; G02B 27/00; G02B 21/16; G02B 21/00

(52) U.S. Cl. CPC G02B 21/33; G02B 21/26; G02B 21/0096; G02B 21/16; G02B 27/0025

(57) ABSTRACT

A microscope includes: a chamber that holds a chamber solution in which a cuvette, which contains a sample together with a cuvette solution, is immersed; an immersion objective lens that is disposed outside the chamber and that collects light coming from the sample; a detection optical system that detects the light collected by the immersion objective lens; and a motorized XYZ stage that supports the cuvette inside the chamber to be movable in a direction parallel to an optical axis of the immersion objective lens. The cuvette and the chamber each have a transparent portion that allows transmission of the light from the sample, and the immersion objective lens is disposed facing the transparent portion of the cuvette, with the transparent portion of the chamber interposed therebetween, and is disposed so that an immersion solution is interposed between said immersion objective lens and the transparent portion of the chamber.

### CROSS-REFERENCE TO RELATED APPLICATIONS

This application is based on Japanese Patent Application No. 2017-088213, the content of which is incorporated herein by reference.

### TECHNICAL FIELD

The present invention relates to microscopes.

### BACKGROUND ART

In the related art, there are known microscopes for observing a sample accommodated in a sample container together with a solution (for example, see Patent Literature 1). Patent Literature 1 discloses a light-sheet microscope having a configuration such that a sample is accommodated in a sample container, such as a cuvette, together with a first liquid medium, the sample container is immersed in a second liquid medium that has the same refractive index as the first liquid medium and that is held in a medium container, and at least a distal-end lens of a detection objective lens having an optical axis in a direction perpendicular to the vertical direction is immersed in the second liquid medium in the medium container, and furthermore, so that the second liquid medium in the medium container does not leak outside, the detection objective lens is fixed, and the sample container is driven by an XYZ-θ (the θ rotation axis is in the vertical direction) stage to obtain a cross-sectional image of the sample.

With such a configuration, refractive index changes are minimized even if the image-acquisition position on the sample changes, thus allowing detection with low focal shifting from a sheet illumination position and a low incidence of spherical aberrations. If the refractive index of the sample and the refractive index of the first liquid medium are exactly the same as the refractive index of the second liquid medium, there are no changes in focusing and no changes in the occurrence of spherical aberrations. In practice, it is not possible to exactly match the refractive index of the first liquid medium and the refractive index of the second liquid medium to the refractive index of the sample, and the refractive index of the sample also differs from location to location, and therefore, due to movement of the sample, a small amount of focal shifting from the sheet illumination position occurs, and aberrations vary. In confocal microscopes and multiphoton-excitation microscopes, the objective lens shares a common optical path for illumination and detection, and therefore, the above-mentioned focus changes do not occur; however, the aberrations vary.

### CITATION LIST

### Patent Literature

{PTL 1}

PCT International Publication No. WO 2015/184124

### SUMMARY OF INVENTION

An aspect of the present invention is a microscope including: a medium container that holds a second liquid medium in which a specimen container, which contains a specimen together with a first liquid medium, is immersed; an immersion objective lens that is disposed outside the medium container and that collects light coming from the specimen; a detection optical system that detects the light collected by the immersion objective lens; and a movable stage that supports the specimen container so as to be movable inside the medium container in at least a direction parallel to an optical axis of the immersion objective lens, wherein the specimen container and the medium container each have a transparent portion that allows transmission of the light from the specimen, and the immersion objective lens is disposed facing the transparent portion of the specimen container, with the transparent portion of the medium container interposed therebetween, and is disposed so that a third liquid medium is interposed between said immersion objective lens and the transparent portion of the medium container.

### BRIEF DESCRIPTION OF DRAWINGS

FIG. 1 is a diagram showing, in outline, the configuration of a microscope according to a first embodiment of the present invention as viewed in a horizontal direction (Y-direction).

FIG. 2 is a diagram showing, in outline, the configuration of a microscope according to a second embodiment of the present invention as viewed in the vertical direction (Z-direction).

FIG. 3 is a cross-sectional view taken along A-A in FIG. 2.

FIG. 4 is a diagram showing, in outline, the configuration of a microscope according to a third embodiment of the present invention as viewed in the vertical direction (Z-direction).

FIG. 5 is a cross-sectional view taken along B-B in FIG. 4.

FIG. 6 is a diagram showing, in outline, the configuration of a microscope according to a fourth embodiment of the present invention, as viewed in a horizontal direction (Y-direction).

### DESCRIPTION OF EMBODIMENTS

### First Embodiment

A microscope according to a first embodiment of the present invention will be described below with reference to the drawings.

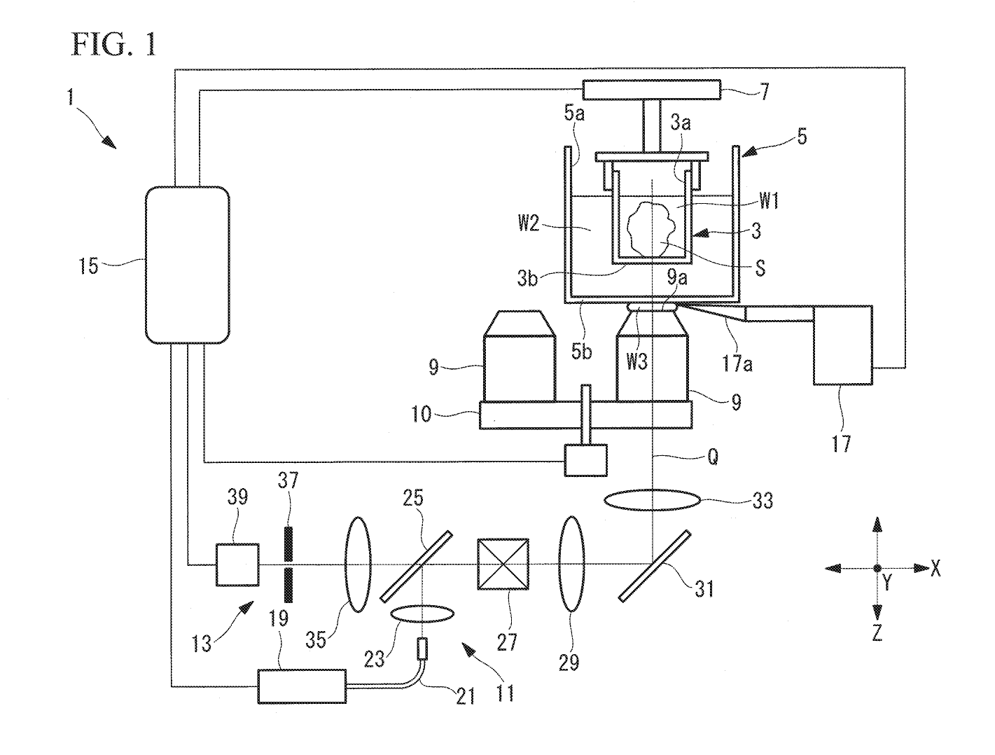

As shown in FIG. 1, a microscope 1 according to this embodiment is configured as an inverted confocal microscope. This microscope 1 includes a cuvette (specimen container) 3 that accommodates a sample (specimen) S; a chamber (medium container) 5 that can accommodate the cuvette 3; a motorized XYZ stage (movable stage) 7 that supports the cuvette 3; a revolver (lens switching part) 10 that supports a plurality of immersion objective lenses 9 outside the chamber 5; an illumination optical system 11 that irradiates the sample S in the cuvette 3 with laser light (excitation light) via an immersion objective lens 9; a detection optical system 13 that detects, via the immersion lens 9, fluorescence produced in the sample due to irradiation with the laser light; and a controller (control unit) 15 that controls the motorized XYZ stage 7, the revolver 10, the illumination optical system 11, and the detection optical system 13 and generates an image.

The cuvette 3 has an opening 3a at the top thereof and has, in the bottom thereof, a transparent portion 3b that allows transmission of the laser light and fluorescence. This cuvette 3 holds a cuvette solution (first liquid medium) W1, such as a transparentizing solution, and the sample S is immersed in the cuvette solution W1. The sample S becomes transparent by being immersed in the cuvette solution W1.

The chamber 5 has a larger volume than the cuvette 3, has an opening 5a at the top thereof, and has, in the bottom thereof, a transparent portion 5b that allows transmission of the laser light and fluorescence. A chamber solution (second liquid medium) W2 having approximately the same refractive index as that of the cuvette solution W1 is held in this chamber 5, and the cuvette 3 is immersed in this chamber solution W2.

The motorized XYZ stage 7 is configured to hold the upper part of the cuvette 3 and to support the cuvette 3 in a state in which the cuvette 3 is immersed into the chamber solution W2 from the opening 5a in the chamber 5. In addition, the motorized XYZ stage 7 is configured so that the cuvette 3 can be moved inside the chamber 5 in the vertical direction (Z direction) and in mutually perpendicular directions that intersect the vertical direction (X direction and Y direction).

The plurality of immersion objective lenses 9 have different magnifications from each other and are each formed by combining multiple lenses (not illustrated). These immersion objective lenses 9 are held pointing vertically upward by the revolver 10, outside and below the chamber 5. In addition, these immersion objective lenses 9 are selectively inserted onto an optical axis Q of the illumination optical system 11 and the detection optical system 13 by means of the revolver 10, and are disposed so as to have a gap with respect to the transparent portion 5b in the bottom of the chamber 5 so as to allow liquid to be held therebetween by means of surface tension. With the revolver 10, it is possible to switch among the immersion objective lenses 9 to be used according to the purpose of the observation, for example.

By means of a liquid feed device (liquid supply device) 17 having a nozzle 17a at the distal end thereof, it is possible to supply the immersion solution (third liquid medium) W3 into the gap between an upper surface 9a of the extreme distal-end lens 9 inserted in the optical axis Q and the transparent portion 5b in the bottom of the chamber 5.

The immersion solution W3 injected into the gap between the upper surface 9a of the immersion objective lens 9 and the transparent portion 5b of the chamber 5, is held in that gap by means of surface tension. The immersion solution W3 is, for example, a silicone solution and has a refractive index approximately equal to that of the cuvette solution W1 and the chamber solution W2.

The illumination optical system 11 includes a laser light source 19 that generates laser light, an optical fiber 21 that guides the laser light emitted from the laser light source 19, and a collimator lens 23 that converts the laser light guided by the optical fiber 21 into a collimated beam.

The illumination optical system 11 includes, as an optical system that is shared with the detection optical system 13: a dichroic mirror 25 that reflects the laser light converted to a collimated beam by the collimator lens 23; an XY scanner 27 that two-dimensionally scans the laser light reflected by the dichroic mirror 25; a relay lens 29 that relays the laser light scanned by the XY scanner 27; a reflecting mirror 31 that reflects the laser light relayed by the relay lens 29; and an image-forming lens 33 that focuses the laser light reflected by the reflecting mirror 31.

The dichroic mirror 25 is configured to reflect the laser light from the collimator lens 23 and to transmit the fluorescence that is emitted from the sample S and that returns along the optical path of the laser light via the immersion objective lens 9, the image-forming lens 33, the reflecting mirror 31, the relay lens 29, and the XY scanner 27.

In addition to the image-forming lens 33, the reflecting mirror 31, the relay lens 29, the XY scanner 27, and the dichroic mirror 25, the detection optical system 13 includes a confocal lens 35 that focuses the fluorescence transmitted through the dichroic mirror 25, a confocal pinhole 37 that allows the fluorescence focused by the confocal lens 35 to partially pass therethrough, and an optical detector 39, such as a photomultiplier tube or the like, that detects the fluorescence that has passed through the confocal pinhole 37.

The confocal pinhole 37 is located at a position conjugate with the focal position of the immersion objective lens 9 so that, of the fluorescence focused by the confocal lens 35, only the fluorescence generated at the focal position of the immersion objective lens 9 in the sample S is allowed to pass therethrough.

The optical detector 39 generates an optical intensity signal corresponding to the intensity of the detected fluorescence and transmits this signal to the controller 15.

The controller 15 includes a CPU (Central Processing Unit), a main storage unit such as a ROM (Read Only Memory) and RAM (Random Access Memory), a secondary storage unit such as an HDD (Hard Disk Drive), an input unit via which the user inputs instructions, an output unit for outputting data, an external interface for performing various types of data exchange with an external device, and so forth (none of which are illustrated). The secondary storage unit stores various programs, and various types of processing are realized by the CPU reading out programs from the secondary storage unit into the main storage unit, such as the RAM or the like, and executing these programs.

Concretely, the controller 15 is configured to control the motion of the cuvette 3 in the X, Y, and Z directions with the motorized XYZ stage 7 by executing a program. Also, by executing a program, the controller 15 is configured to control the laser light source 19 and the optical detector 39, and to control the switching of the immersion objective lenses by the revolver 10 and the supply of the immersion solution W3 by the liquid feed device 17 at the time of switching of the immersion objective lenses 9. Furthermore, the controller 15 is configured to generate an image of the sample S on the basis of the optical intensity signal output from the optical detector 39.

The operation of the microscope 1 having such a configuration will now be described.

To observe the sample S with the microscope 1 according to this embodiment, first, the motorized XYZ stage 7 is driven by the controller 15 to immerse the cuvette 3 containing the sample S and the cuvette solution W1 in the chamber solution W2 inside the chamber 5, and the target observation position on the sample S is moved onto the optical axis Q.

Next, the controller 15 causes the laser light source 19 to emit laser light. After the laser light emitted from the laser light source 19 is guided by the optical fiber 21 and converted to a collimated beam by the collimator lens 23, the laser light is reflected by the dichroic mirror 25, is two-dimensionally scanned by the XY scanner 27, and is focused by the immersion objective lens 9 via the relay lens 29, the reflecting mirror 31, and the image-forming lens 33.

The laser light focused by the immersion objective lens 9 passes through the transparent portion 5b in the bottom of the chamber 5 via the immersion solution W3, and irradiates the sample S parallel to the optical axis Q via the chamber solution W2 in the chamber 5, the transparent portion 3b in the bottom of the cuvette 3, and the cuvette solution W1. Upon irradiating the sample with the laser light, a fluorescent substance inside the sample S is excited, producing fluorescence.

Of the fluorescence produced in the sample S, the fluorescence radiated in the direction parallel to the optical axis Q returns along the light path of the laser light via the cuvette solution W1, the transparent portion 3b in the bottom of the cuvette 3, the chamber solution W2, the transparent portion 5b in the bottom of the chamber 5, and the immersion solution W3, and is collected by the immersion objective lens 9.

The fluorescence collected by the immersion objective lens 9 returns along the light path of the laser light via the image-forming lens 33, the reflecting mirror 31, the relay lens 29, and the XY scanner 27, is transmitted through the dichroic mirror 25, and is focused by the confocal lens 35. Of the fluorescence focused by the confocal lens 35, the fluorescence produced at the focal position of the immersion objective lens 9 passes through the confocal pinhole 37 and is detected by the optical detector 39. Then, on the basis of the optical intensity signal output from the optical detector 39, a two-dimensional image of the sample S is generated by the controller 15.

The motorized XYZ stage 7 is driven by the controller 15 to move the cuvette 3 in the X, Y, and Z directions inside the chamber 5, whereby the observation position on the sample S can be changed, and a cross-sectional image at each observation position can be obtained.

In this case, even though the cuvette 3 is moved inside the chamber 5 to change the observation position on the sample S, the relative positions of the immersion objective lens 9 and the chamber 5 do not change, and therefore, the thickness of the immersion solution W3 disposed between the distal end of the immersion objective lens 9 and the transparent portion 5b in the bottom of the chamber 5 does not change. Accordingly, the immersion solution W3 does not run out as a result of changing the observation position, and in addition, it is not necessary to prepare nor to frequently supply a large amount of the immersion solution W3 between the distal end of the immersion objective lens 9 and the transparent portion 5b of the chamber 5. In particular, since the silicone solution used as the immersion solution W3 is nonvolatile, there is little risk of the solution drying out, and it is possible to achieve long-term observation without having to frequently supply the immersion solution W3.

In addition, even though the cuvette 3 is moved inside the chamber 5, thus changing the observation position, since the laser light focal position and the fluorescence detection position are coincident, focal shifting does not occur. Thus, confocal fluorescence observation of cross-sectional images at different observation positions in the sample S is possible without having to finely adjust the focal position of the immersion objective lens 9.

Therefore, with the microscope 1 according to this embodiment, it is possible to stably hold the immersion solution W3 between the immersion objective lens 9 and the chamber 5, and it is thus possible to simplify maintenance of the apparatus as well as to improve the reliability.

In this embodiment, the cuvette solution W1 and the chamber solution W2 have approximately equal refractive indexes. Although, from the viewpoint of spherical aberration, ideally the refractive indexes of the cuvette solution W1 and the chamber solution W2 should be approximately equal to each other, the refractive indexes of the cuvette solution W1 and the chamber solution W2 may be different from each other. For example, although the cuvette solution W1 is a transparentizing solution, from the viewpoint of cost, instead of using the same transparentizing solution for the chamber solution W2, a lower-cost solution having a refractive index close thereto may be used.

Furthermore, in the microscope 1 according to this embodiment, focal shifting due to changes in the observation position does not occur; however, when obtaining a plurality of cross-sectional images (stacked images) of the sample S in the direction parallel to the optical axis Q, the observation positions of the individual cross-sectional images are not at equal intervals. Thus, for example, an aiming part for finely adjusting the position of the immersion objective lens 9 in the direction parallel to the optical axis Q may be provided, and the spacings between the plurality of cross-sectional images may be corrected so as to become equal.

In this embodiment, it has been assumed that the immersion solution W3 has approximately the same refractive index as those of the chamber solution W2 and the cuvette solution W1; however, the immersion solution W3 may have a different refractive index from those of the chamber solution W2 and the cuvette solution W1. In this case, it suffices to provide, in advance, a correction ring (spherical aberration adjusting mechanism) or the like on the immersion objective lens 9, and to correct the spherical aberration using the correction ring or the like. Since spherical aberration changes when the observation position changes, spherical aberration may be corrected by matching the observation position using the correction ring, for example, either by means of control with the controller 15 or manually.

In this embodiment, although a silicone solution has been illustrated as an example of the immersion solution W3, instead of this, for example, purified water or the like may be used. The advantages of using water include low cost and the ease of performing purification.

### Second Embodiment

Next, a microscope according to a second embodiment of the present invention will be described.

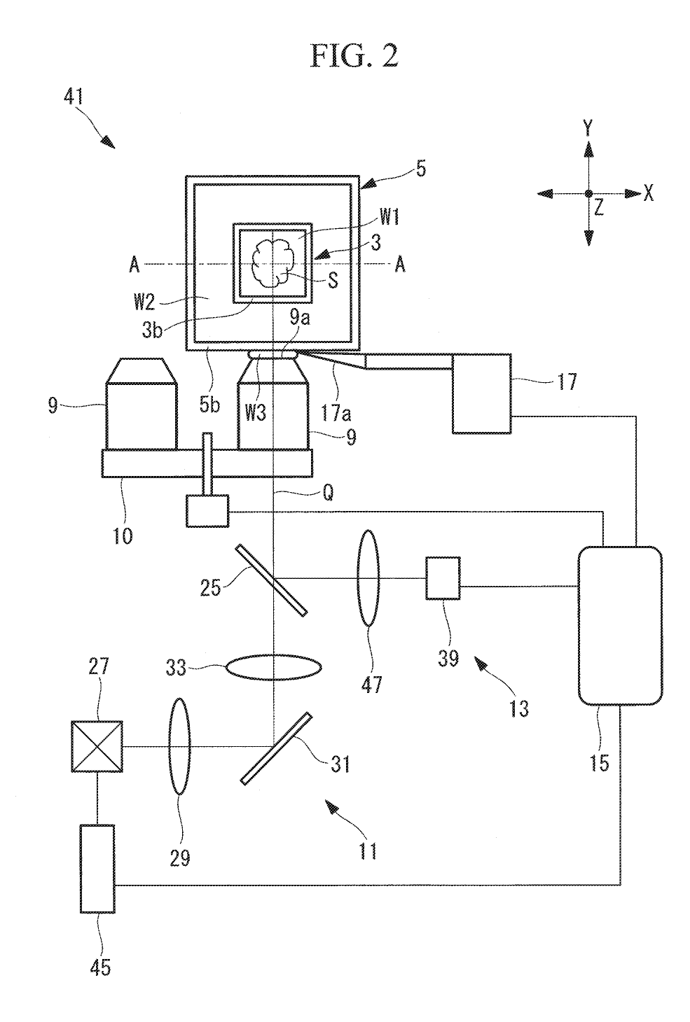

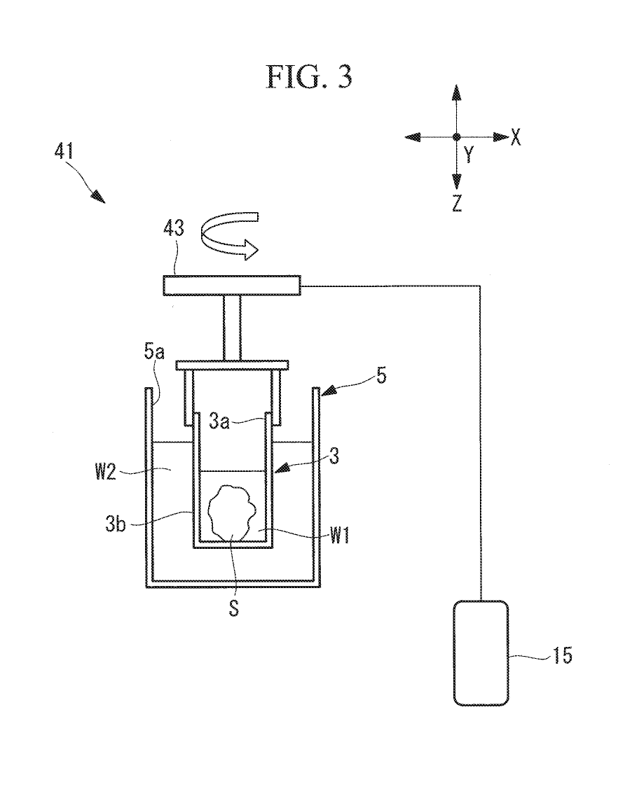

As shown in FIG. 2 and FIG. 3, a microscope 41 according to this embodiment differs from that in the first embodiment in that the microscope 41 is configured as a multiphoton-excitation microscope.

In the following, parts having the same configuration as those in the microscope 1 according to the first embodiment are assigned the same reference signs, and a description thereof is omitted.

The microscope 41 includes a cuvette 3; a chamber 5; a motorized XYZ-θ stage 43 that is capable of moving in the X, Y and Z directions, as well as rotation about a prescribed rotation axis parallel to the Z direction; immersion objective lenses 9 and a revolver 10; an illumination optical system 11; a detection optical system 13, and a controller 15. In this microscope 41, an optical axis Q of the illumination optical system 11 and the detection optical system 13 is disposed parallel to the Y direction.

In this embodiment, the cuvette 3 has, extending around the entirety thereof in the circumferential direction of side wall portions, a transparent portion 3b that is capable of transmitting laser light and fluorescence. The chamber 5 also has, in at least one side wall portion thereof, a transparent portion 5b that is capable of transmitting the laser light and fluorescence.

The plurality of immersion objective lenses 9 are held by the revolver 10, so as to be oriented horizontally and laterally, and facing the transparent portion 5b in the side wall portion of the chamber 5.

These immersion objective lenses 9 are selectively inserted in the optical axis Q of the illumination optical system 11 and the detection optical system 13 by the revolver 10, and are disposed so as to oppose the transparent portion 5b in the side wall portion of the chamber 5, with a gap therebetween that allows the immersion solution W3 to be held therein by surface tension.

The illumination optical system 11 includes, instead of the laser light source 19, a laser light source 45 that generates ultrashort-pulse laser light, and is also provided with an XY scanner 27, a relay lens 29, an image-forming lens 33, and a dichroic mirror 25 that is shared with the detection optical system 13.

In this embodiment, the dichroic mirror 25 is disposed between the immersion objective lens 9 and the image-forming lens 33, so as to transmit the laser light from the image-forming lens 33 and reflect fluorescence that is collected by the immersion objective lens 9 and that returns along the light path of the laser light.

The detection optical system 13 includes, in addition to the dichroic mirror 25, a focusing lens 47 that focuses the fluorescence reflected by the dichroic mirror 25, and an optical detector 39 that detects the fluorescence focused by the focusing lens 47.

The operation of the thus-configured microscope 41 will be described below.

To observe a sample S with the microscope 41 according to this embodiment, the motorized XYZ stage 7 is driven by the controller 15 so that the cuvette 3, which contains the sample S and the cuvette solution W1, is immersed in the chamber solution W2 in the chamber 5 to move the target observation position onto the optical axis Q, and ultrashort-pulse laser light is caused to be emitted from the laser light source 45.

The ultrashort-pulse laser light emitted from the laser light source 45 (hereinafter referred to simply as laser light) is two-dimensionally scanned by the XY scanner 27 and is relayed by the relay lens 29, after which the laser light is reflected by the reflecting mirror 31, is focused by the image-forming lens 33, is transmitted through the dichroic mirror 25, and is focused by the immersion objective lens 9.

The laser light focused by the immersion objective lens 9 is transmitted through the transparent portion 5b in the side wall portion of the chamber 5 via the immersion solution W3, passes through the chamber solution W2 in the chamber 5, the transparent portion 3b in the side wall portion of the cuvette 3, and the cuvette solution W1, and irradiates the sample S parallel to the optical axis Q. By irradiating the sample S with the ultrashort-pulse laser light, a fluorescent substance at the irradiation position in the sample S is excited via the multiphoton-excitation effect, thus producing fluorescence.

Of the fluorescence produced in the sample S via the multiphoton-excitation effect, the fluorescence radiated in a direction parallel to the optical axis Q returns along the light path of the laser light via the cuvette solution W, the transparent portion 3b in the side-wall portion of the cuvette 3, the chamber solution W2, the transparent portion 5b in the side wall portion of the chamber 5 and the immersion solution W3 and is collected by the immersion objective lens 9.

The fluorescence collected by the immersion objective lens 9 is reflected by the dichroic mirror 25 without returning to the XY scanner 27, is focused by the focusing lens 47, and is detected by the optical detector 39. Then, on the basis of an optical intensity signal output from the optical detector 39, a two-dimensional image of the sample S is generated by the controller 15.

By driving the motorized XYZ stage 7 with the controller 15 so as to move the cuvette 3 in the X, Y, and Z directions inside the chamber 5, the observation position on the sample S can be changed, and it is possible to acquire cross-sectional images at the individual observation positions. Furthermore, by rotating the motorized XYZ-θ stage 43 about a prescribed rotation axis parallel to the Z direction with the controller 15 so as to invert the cuvette 3 about the rotation axis, a region in the sample S far from the immersion objective lens 9 can be brought closer to the immersion objective lens 9. Accordingly, a superior sample image is obtained over the entire region of the sample S.

In this case, even if the cuvette 3 is moved inside the chamber 5 to change the observation position on the sample S, the relative positions of the immersion objective lens 9 and the chamber 5 do not change, and therefore, the thickness of the immersion solution W3 disposed between the distal end of the immersion objective lens 9 and the transparent portion 5b in the side wall portion of the chamber 5 does not change. Accordingly, it is not necessary to prepare nor frequently supply a large amount of the immersion solution W3. In addition, since the focal position of the laser light and the detection position of the fluorescence are coincident, no focal shifting occurs. Accordingly, multiphoton-excitation observation of cross-sectional images at different observation positions in the sample S is possible without having to finely adjust the focus position of the immersion objective lens 9.

Therefore, with the microscope 41 of this embodiment, too, the immersion solution W3 can be stably held between the immersion objective lens 9 and the chamber 5, and it is possible to simplify maintenance of the apparatus as well as to improve reliability.

### Third Embodiment

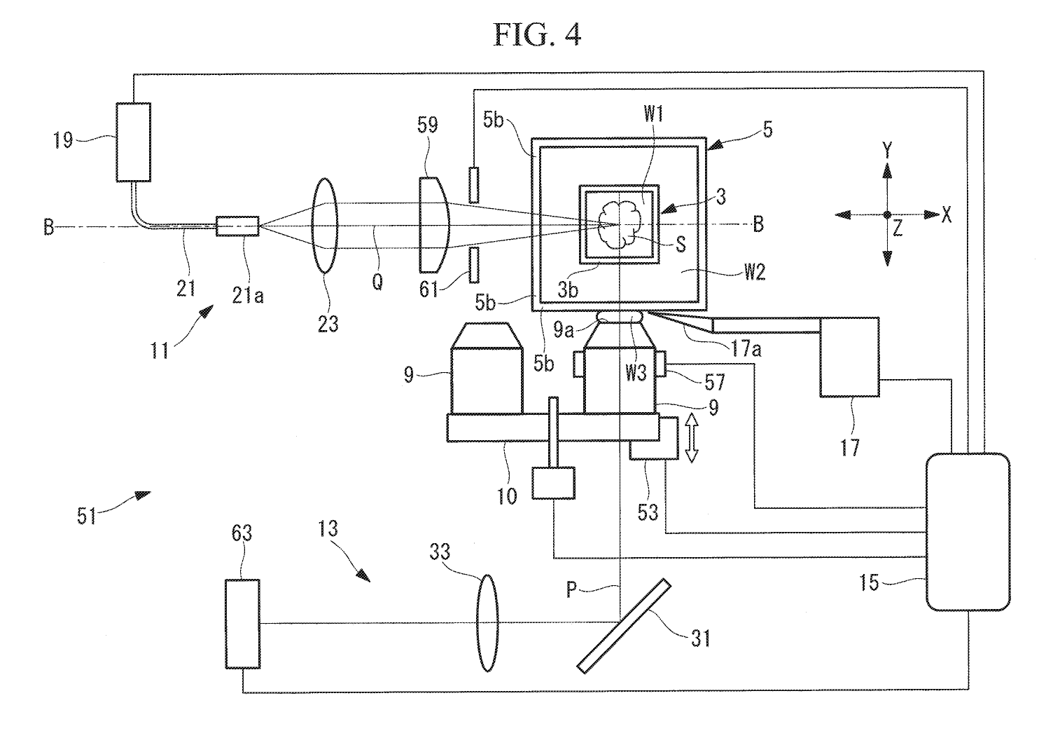

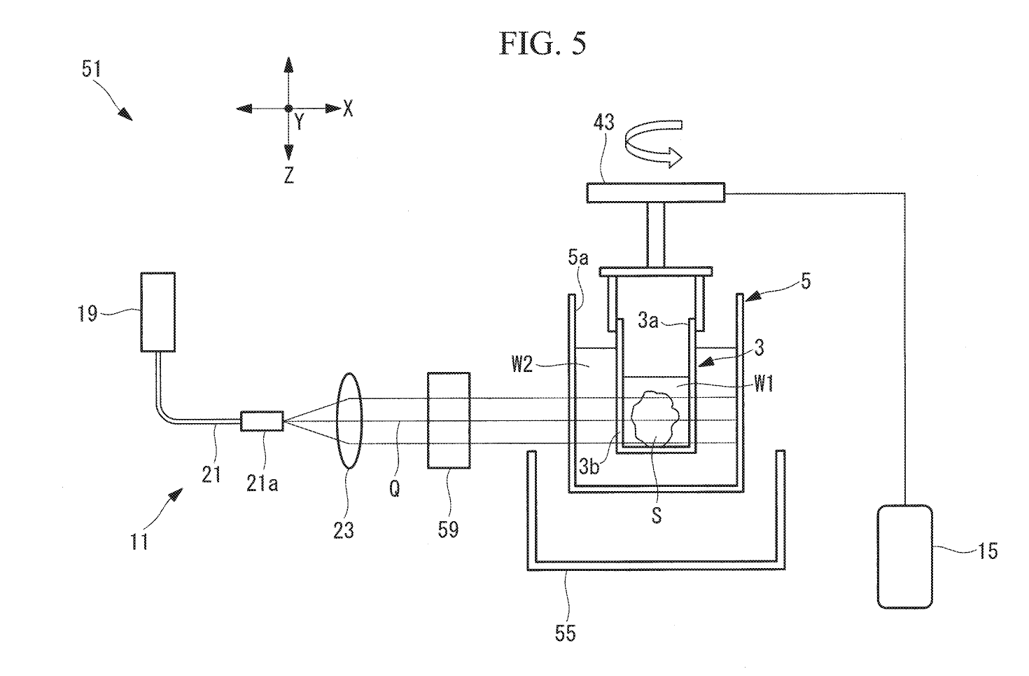

As shown in FIG. 4 and FIG. 5, a microscope 51 according to this embodiment differs from those in the first embodiment and the second embodiment in that the microscope 51 is configured as a light-sheet microscope.

In the following, parts having the same configuration as those in the microscope 1 according to the first embodiment and the microscope 41 according to the second embodiment are assigned the same reference signs, and a description thereof is omitted.

The microscope 51 includes: a cuvette 3; a chamber 5; a motorized XYZ-θ stage 43; immersion objective lenses 9 and a revolver 10; an aiming part 53 that moves the revolver 10 in the direction parallel to the optical axis of the immersion objective lenses 9; an illumination optical system 11; a detection optical system 13; and a controller 15. In FIG. 5, reference sign 55 indicates a drain tank. The illumination optical system 11 has an optical axis Q parallel to the Y direction, and the detection optical system 13 has an optical axis P parallel to the X direction.

In this embodiment, the cuvette 3 has a transparent portion 3b extending around the entirety thereof in the in the circumferential direction of side wall portions. The chamber 5 has a transparent portion 5b in two mutually adjacent side wall portions.

The immersion objective lenses 9 are held by the revolver 10, so as to be oriented horizontally and laterally, and facing the transparent portion 5b in one of the side-wall portions of the chamber 5. These immersion objective lenses 9 are selectively inserted onto the optical axis Q of the illumination optical system 11 by the revolver 10, and are disposed facing the transparent portion 5b in the side wall portion of the chamber 5 with a gap therebetween that holds the immersion solution therein by means of surface tension. In this embodiment, the immersion objective lens 9 is provided with a motorized correction ring (spherical aberration adjustment mechanism) 57 that adjusts the spherical aberration.

The illumination optical system 11 includes: a laser light source 19; an optical fiber 21; a collimator lens 23; a cylindrical lens 59 that focuses the laser light converted to a collimated beam by the collimator lens 23; and a variable aperture 61 that can vary the beam diameter of the laser light focused by the cylindrical lens 59.

The cylindrical lens 59 has power in one direction perpendicular to the optical axis Q of the illumination optical system 11. This cylindrical lens 59 focuses laser light formed of a substantially collimated beam into the form of plane having a prescribed width dimension the same as the beam diameter thereof, and brings the laser light to a focus on the optical axis of the immersion objective lens 9.

The variable aperture 61 is disposed between the cylindrical lens 59 and the transparent portion 5b in the other side wall portion of the chamber 5. By varying the beam diameter of the laser light with the variable aperture 61, it is possible to vary the thickness of the laser light focused in the form of a plane by the cylindrical lens 59. This variation in thickness is conducted according to the immersion objective lens 9 that is inserted in the light path.

A distal end portion 21a of the optical fiber 21, the collimator lens 23, the cylindrical lens 59, and the variable aperture 61 are disposed facing the transparent portion 5b in the other side wall portion of the chamber 5, and the laser light emitted from the laser light source 19 is made incident on the sample S via the transparent portion 5b in the other side wall portion of the chamber 5 and the transparent portion 3b in the side wall portion of the cuvette 3.

The detection optical system 13 includes: a reflecting mirror 31 that reflects fluorescence collected by the immersion objective lens 9; an image-forming lens 33 that forms an image of the fluorescence reflected by the reflecting mirror 31; and a camera 63 that captures the fluorescence image formed by the image-forming lens 33.

The aiming part 53 causes the immersion objective lens 9 to finely move in a direction parallel to the optical axis, within a range where the surface tension of the immersion solution acts in the gap between a top face 9a of the extreme distal-end lens in the immersion objective lens 9 and the transparent portion 5b in the side wall portion of the chamber 5, whereby it is possible to finely adjust the focal position of the immersion objective lens 9 in a direction parallel to the optical axis P of the detection optical system 13.

In addition to control of the laser light source 19 and the camera 63, control of the motorized XYZ-θ stage 43, control of the revolver 10, control of the liquid feed device 17, and image generation, the controller 15 controls adjustment of the beam diameter of the laser light by the variable aperture 61, correction of spherical aberration by the motorized correction ring 57 according to the motion of the motorized XYZ-θ stage 43, and fine adjustment of the position of the immersion objective lens 9 in the direction parallel to the optical axis of the detection optical system 13 by the aiming part 53.

The operation of the thus-configured microscope 51 will now be described.

To observe the sample S with the microscope 51 according to this embodiment, first, the motorized XYZ-θ stage 43 is driven by the controller 15 to immerse the cuvette 3 containing the sample S and the cuvette solution W1 into the chamber solution W2 inside the chamber 5 and to move the target observation position onto the optical axis Q and the optical axis P, and the laser light source 19 is made to emit laser light.

The laser light emitted from the laser light source 19 is guided by the optical fiber 21 and is converted to a collimated beam by the collimator lens 23, after which, the laser light is focused in the form of a plane by the cylindrical lens 59, passes through the variable aperture 61, is transmitted through the transparent portion 5b in the side wall portion of the chamber 5, and enters the chamber 5.

The laser light that has entered the chamber 5 passes through the chamber solution W2, the transparent portion 3b in the side wall portion of the cuvette 3, and the cuvettes solution W1 and is incident on the sample S from a direction perpendicular to the optical axis P of the detection optical system 13. By causing planar laser light to be incident on the sample S, a fluorescent substance inside the sample S is excited parallel to the plane of incidence of the laser light, thus producing fluorescence.

Of the fluorescence produced in the sample S, the fluorescence radiated in a direction parallel to the optical axis P of the detection optical system 13 passes through the cuvette solution W1, the transparent portion 3b in the side wall portion of the cuvette 3, the chamber solution W2, the transparent portion 5b in the side wall portion of the chamber 5, and the immersion solution W3, and is collected by the immersion objective lens 9.

The fluorescence collected by the immersion objective lens 9 is reflected by the reflecting mirror 31 and forms an image on an image-capturing surface of the camera 63 via the image-forming lens 33. Accordingly, a cross-sectional image of the sample S, perpendicular to the optical axis P, is obtained in the camera 63. Then, the motorized XYZ-θ stage 43 is driven by the controller 15 to move the cuvette 3 in the X, Y, and Z directions inside the chamber 5, whereby it is possible to change the observation position on the sample S, and to acquire cross-sectional images at the individual observation positions.

Furthermore, the motorized XYZ-θ stage 43 is driven by the controller 15 to rotate the cuvette 3 about a prescribed rotation axis parallel to the Z direction and invert the orientation of the sample S with respect to the immersion objective lens 9, so that a region in the sample S far from the immersion objective lens 9 is brought closer to the immersion objective lens 9, whereby a superior image of substantially the entire area of the sample S can be acquired.

Thus, by making the focal position of the cylindrical lens 59 coincident with the optical axis (optical axis P) of the immersion objective lens 9, and by making focal plane of the immersion objective lens 9 coincident with the plane of incidence of the laser light, it is possible to focus, all at once, the fluorescence produced in a wide area parallel to the focal plane of the immersion objective lens 9 with the immersion objective lens 9 and acquire an image with the camera 63, and it is thus possible to obtain a clear fluorescence image of the observation region on the sample S. Furthermore, since the laser light does not irradiate areas outside the image-acquisition plane of the camera 63, fading of the fluorescence can be suppressed, and it is possible to obtain a superior three-dimensional image.

In this case, even though the cuvette 3 is moved inside the chamber 5 to change the observation position on the sample S, the thickness of the immersion solution W3 disposed in the gap between the immersion objective lens 9 and the chamber 5 does not change (is maintained the same due to surface tension, even with fine adjustment of the focus), and therefore, it is possible to prevent the immersion solution W3 from drying out, and it is not necessary to prepare a large amount of nor frequently supply the immersion solution W3.

Furthermore, when the observation position on the sample S is changed, even though a shift in the focal position of the immersion objective lens 9 occurs according to the refractive index distribution in the sample S, and even though a shift in the focal position of the immersion objective lens 9 occurs to do a slight difference between the refractive index of the cuvette solution W1 and refractive index of the chamber solution W2, it is possible, by means of the aiming part 53, to eliminate a shift in focal position by an amount corresponding to the fine adjustment of the immersion objective lens 9 in the direction parallel to the optical axis P. In addition, by correcting the focus shift with the aiming part 53, although the liquid thickness of the immersion solution W3 changes, thus changing the spherical aberration, it is possible to control the motorized correction ring 57 with the controller 15 to correct the spherical aberration.

Therefore, with the microscope 51 according to this embodiment, too, it is possible to stably hold the immersion solution W3 between the immersion objective lens 9 and the chamber 5, and it is possible to simplify maintenance of the apparatus and to improve reliability.

In this embodiment, a sheet-light microscope has been illustrated as an example; however, this embodiment may also be applied to a light-field microscope. In this case, the illumination optical system 11 is further provided with a second cylindrical lens (not illustrated) having negative power, and the second cylindrical lens should be disposed between the cylindrical lens 59 and the chamber 5 so that laser light having a thickness in a direction parallel to the image-acquisition optical axis of the camera 63 is made incident on the sample S. In addition, it suffices to provide the detection optical system 13 with a microlens array formed of a plurality of microlenses that project images onto the image-acquisition surface of the camera 63 and an image-forming lens that forms an image on the microlens array (neither of which are illustrated in the drawings). By doing so, it is possible to acquire, at one time, a plurality of sets of image information having different degrees of parallax.

### Fourth Embodiment

Next, a microscope according to a fourth embodiment of the present invention will be described.

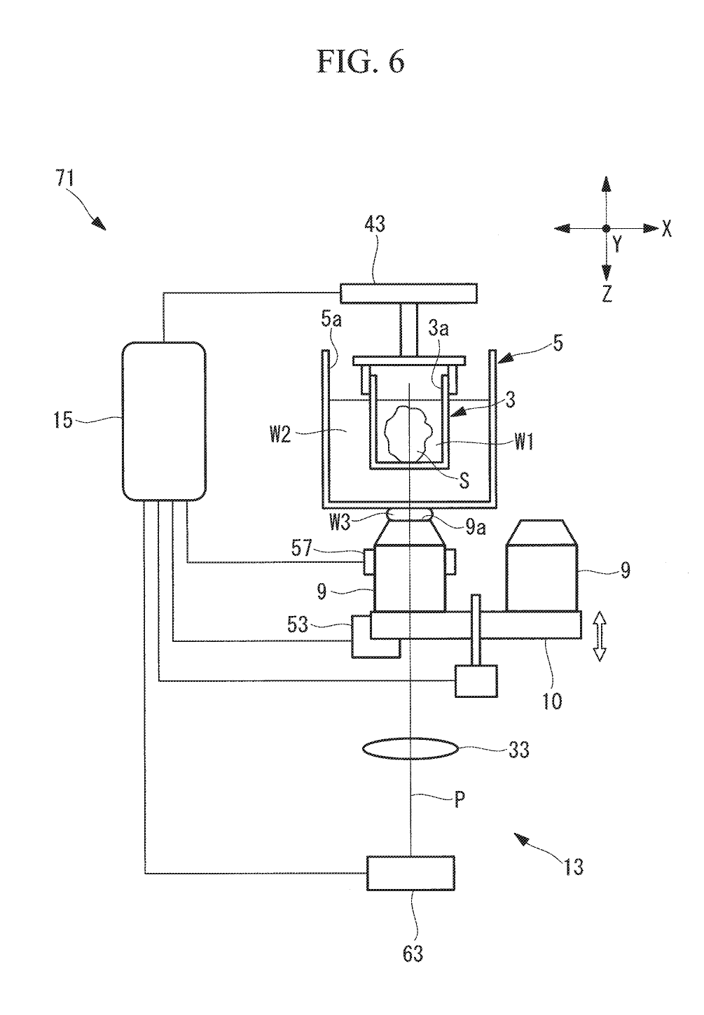

As shown in FIG. 6, the microscope 71 according to this embodiment differs from those in the first to third embodiments in that the microscope 71 is configured as a luminescent microscope.

In the following, parts having the same configuration as the microscopes 1, 41, and 51 in the first to third embodiments are assigned the same reference numerals, and a description thereof is omitted.

The microscope 71 is not provided with the illumination optical system 11, but is provided with: a cuvette 3; a chamber 5; a motorized XYZ-θ stage 43; immersion objective lenses 9 and a revolver 10; an aiming part 53; a detection optical system 13; and a controller 15. In this microscope 71, the optical axis P of the detection optical system 13 is disposed parallel to the Z direction.

In this embodiment, the cuvette 3 has, in the bottom thereof, a transparent portion 3b that allows light to be transmitted therethrough. The chamber 5 also has, in the bottom thereof, a transparent portion 5b that allows light to be transmitted therethrough.

The immersion objective lenses 9 are disposed close to the transparent portion 5b in the bottom of the chamber 5, outside the chamber 5, and are oriented vertically upward with respect to the transparent portion 5b. In addition, one immersion objective lens 9 is disposed facing the transparent portion 5b in the bottom of the chamber 5, with a gap therebetween that allows the immersion solution W3 to be held therein by means of surface tension. In this embodiment too, the immersion objective lens 9 is provided with a motorized correction ring 57 that adjusts the spherical aberration.

The detection optical system 13 is provided with an image-forming lens 33 and a camera 63.

In addition to control of the revolver 10 and image generation, the controller 15 controls correction of spherical aberration by the motorized correction ring 57 due to motion of the motorized XYZ-θ stage 43, and fine adjustment of the position of the immersion objective lens 9 in a direction parallel to the optical axis P of the detection optical system, with the aiming part 53.

The operation of the thus-configured microscope 71 will now be described.

To observe a sample S with the microscope 71 according to this embodiment, first, the motorized XYZ-θ stage 43 is driven by the controller 15 to immerse the cuvette 3, which contains the sample S and the cuvette solution W1, into the chamber solution W2 in the chamber 5, and move the target observation position onto the optical axis P.

Of the autoluminescence from the sample S, the luminescence radiated in a direction parallel to the optical axis P of the detection optical system 13 passes through the cuvette solution W1, the transparent portion 3b in the bottom of the cuvette 3, the chamber solution W2, the transparent portion 5b in the bottom of the chamber 5, and the immersion solution W3, is collected by the immersion objective lens 9, and is imaged on the image-capturing surface of the camera 63 by the image-forming lens 33.

Accordingly, a cross-sectional image of the sample P, perpendicular to the optical axis P, is obtained in the camera 63. Then, the motorized XYZ-θ stage 43 is driven by the controller 15 to move the cuvette 3 in the X, Y, and Z directions in the chamber 5, whereby the observation position on the sample S can be changed, and cross-sectional images of the individual observation positions can be obtained.

In this case, when the cuvette 3 is moved inside the chamber 5 to change the observation position on the sample S, even though a shift in the focal position of the immersion objective lens 9 occurs according to the refractive index distribution in the sample S, and even though a shift in the focal position of the immersion objective lens 9 occurs to do a slight difference between the refractive index of the cuvette solution W1 and refractive index of the chamber solution W2, it is possible, by means of the aiming part 53 to eliminate a shift in focal position by an amount corresponding to the fine adjustment of the immersion objective lens 9 in the direction parallel to the optical axis P of the detection optical system 13.

Therefore, with the microscope 71 according to this embodiment, even if there is a refractive index distribution in the sample and a slight difference between the refractive index of the cuvette solution W1 an the refractive index of the chamber solution W2, when the motorized XYZ-θ stage 43 is driven and stacked images acquired at equal intervals in the Z direction are acquired, by performing fine focus adjustment with the aiming part 53, it is possible to obtain equally spaced images, and it is possible to construct a distortion-free three-dimensional image. In addition, merely by eliminating the need for a light source and illumination optical system, a simple and low-cost configuration can be achieved.

Although embodiments of the present invention have been described above with reference to the drawings, the specific configuration is not limited to these embodiments, and design modifications and so forth that do not depart from the scope of the present invention are also encompassed. For example, the present invention is not limited to being applied to the above-described embodiments and modifications and may be applied to embodiments formed by appropriately combining these embodiments and modifications, without particular limitation.

In each of the above-described embodiments, it has been assumed that the cuvette solution W1, the chamber solution W2, the immersion solution W3, the transparent portion 3b of the cuvette 3, and the transparent portion 5b of the chamber 5 all have approximately the same refractive indexes; however, if the thickness of the transparent portion 3b of the cuvette 3 and the thickness of the transparent portion 5b of the chamber 5 are both fixed, even when the cuvette 3 is moved inside the chamber 5, because the refractive indexes of the transparent portion 3b of the cuvette 3 and the transparent portion 5b of the chamber 5, which transmit excitation light and fluorescence, do not change, it suffices that at least the cuvette solution W1 and the chamber solution W2 have approximately the same refractive indexes as each other.

As a result, the following aspects of the invention are derived from the above-described embodiments.

An aspect of the present invention is a microscope including: a medium container that holds a second liquid medium in which a specimen container, which contains a specimen together with a first liquid medium, is immersed; an immersion objective lens that is disposed outside the medium container and that collects light coming from the specimen; a detection optical system that detects the light collected by the immersion objective lens; and a movable stage that supports the specimen container so as to be movable inside the medium container in at least a direction parallel to an optical axis of the immersion objective lens, wherein the specimen container and the medium container each have a transparent portion that allows transmission of the light from the specimen, and the immersion objective lens is disposed facing the transparent portion in the specimen container, with the transparent portion of the medium container interposed therebetween, and is disposed so that a third liquid medium is interposed between said immersion objective lens and the transparent portion of the medium container.

According to this aspect, the specimen is contained in the specimen container together with the first liquid medium, and the entire specimen container is immersed in the second liquid medium in the medium container. Then, the light coming from the specimen passes through the first liquid medium, the transparent portion of the specimen container, the second liquid medium, the transparent portion of the medium container, and the third liquid medium, is collected by the immersion objective lens, and is detected by the detection optical system. Therefore, by moving the specimen container, with the movable stage, in the medium container in a direction parallel to the optical axis of the immersion objective lens, it is possible to acquire a cross-sectional image of the specimen intersecting the optical axis of the immersion objective lens.

In this case, even though the specimen container is moved inside the medium container by the movable stage, thus changing the observation position, the relative positions of the immersion objective lens and the medium container do not change, and therefore, the thickness of the third liquid medium between the distal end of the immersion objective lens and the transparent portion of the medium container does not change. Thus, the third liquid medium does not run out due to changes in the observation position, and it is not necessary to prepare a large amount of nor frequently supply the third liquid medium between the distal end of the immersion objective lens and the transparent portion of the medium container. Accordingly, it is possible to stably hold the third liquid medium between the immersion objective lens and the medium container, and it is possible to simplify the maintenance of the apparatus and to improve reliability.

The above-described aspect may further include a liquid supply device that supplies the third liquid medium between the transparent portion of the medium container and the immersion objective lens.

With this configuration, it is possible to easily supply the third liquid medium between the transparent portion of the medium container and the immersion objective lens with the liquid supply device. For example, this is effective in the case where the immersion objective lens is changed to another immersion objective lens having a different magnification, and the case where the position of the immersion objective lens is finely adjusted in a direction parallel to the optical axis thereof.

In the above-described aspect, the immersion objective lens may be disposed facing the optical axis in a direction intersecting a vertical direction, and the third liquid medium may be held between the immersion objective lens and the transparent portion of the medium container by means of surface tension.

With this configuration, a mechanism for holding the third liquid medium between the distal end of the immersion objective lens and the transparent portion of the medium container is not necessary, and a simple configuration can thus be achieved.

In the above-described aspect, the specimen container and the medium container may have the transparent portions in respective side walls thereof, and the immersion objective lens may be disposed facing the optical axis in a direction substantially perpendicular to the vertical direction.

With this configuration, it is possible to bring the immersion objective lens close to the side wall at the side of the medium, with the third liquid medium interposed therebetween.

In the above-described aspect, the immersion objective lens may be supported so as to be movable in a direction parallel to the optical axis.

By doing so, when the excitation light focused in the form of a plane parallel to a plane intersecting the optical axis of the detection optical system irradiates the specimen, the focal plane of the immersion objective lens can be made coincident with the plane of incidence of the excitation light, light produced in a wide area parallel to the focal plane can be collected at one time with the immersion objective lens, and a high-resolution image can thus be acquired. In this case, when the observation position on the specimen has changed, even if a shift occurs in the focal position of the immersion objective lens according to the refractive index distribution in the specimen, the position of the immersion objective lens in a direction parallel to the optical axis thereof can be finely adjusted, and the shift in focal position can be eliminated.

In the above-described aspect, the first liquid medium and the second liquid medium may have substantially the same refractive indexes as each other.

With this configuration, it is possible to suppress the occurrence of spherical aberration due to a change in the observation position on the specimen, and the first liquid medium and the second liquid medium can be made to have equal spacing.

In the above-described aspect, the third liquid medium may have substantially the same refractive index as the second liquid medium.

With this configuration, it is possible to suppress the occurrence of spherical aberration.

In the above-described aspect, the detection optical system may include a spherical-aberration adjustment mechanism that adjusts spherical aberration.

With this configuration, even if the spherical aberration changes due to a change in the observation position, it is possible to correct the spherical aberration with the spherical-aberration adjustment mechanism.

The above-described aspect may further include a control unit that controls the spherical-aberration adjustment mechanism according to the movement of the movable stage to correct the spherical aberration.

With this configuration, by means of the control unit, it is possible to automatically correct the spherical aberration to match the observation position.

The above-described aspect may further include a lens switching part that switches the immersion objective lens to another immersion objective lens having a different magnification.

With this configuration, with the lens switching mechanism, it is possible to change the magnification of the immersion objective lens and observe the specimen.

The above-described aspect may further include a confocal pinhole that is disposed at a position conjugate with a focal position of the immersion objective lens and that partially allows fluorescence coming from the specimen and collected by the immersion objective lens to pass therethrough, wherein the detection optical system may irradiate the specimen with excitation light emitted from a light source and detect the fluorescence that is produced in the specimen irradiated with the excitation light and that is passes through the confocal pinhole.

With this configuration, it is possible to acquire a confocal fluorescence image. In this case, even though the specimen container is moved inside the medium container by the movable stage, thus changing the observation position, since the focal position and the detection position are coincident, no focal shifting occurs. Therefore, it is possible to perform confocal fluorescence observation of different observation positions in the specimen without having to finely adjust the focal position of the immersion objective lens.

In the above-described aspect, the immersion objective lens may irradiate the specimen with ultrashort-pulse laser light emitted from a light source and collects fluorescence produced in the specimen as a result of a multiphoton excitation effect due to being irradiated with the ultrashort-pulse laser light; and the detection optical system may detect the fluorescence collected by the immersion objective lens.

With this configuration, it is possible to acquire a multiphoton-excitation image. In this case, even though the specimen container is moved inside the medium container by the movable stage, thus changing the observation position, since the focal position and the detection position are coincident, no focal shifting occurs. Therefore, it is possible to perform multiphoton-excitation observation of different observation positions in the specimen without having to finely adjust the focal position of the immersion objective lens.

The microscope according to this invention affords the advantage that immersion liquid can be stably held between an immersion objective lens and a medium container, maintenance of the apparatus can be simplified, and reliability can be improved.

### REFERENCE SIGNS LIST

1, 41, 51, 71 microscope
3 cuvette (specimen container)
3b, 5b transparent portion
5 chamber (medium container)
7 motorized XYZ stage (movable stage)
9 immersion objective lens
10 revolver (lens switching portion)
13 detection optical system
15 controller (control unit)
17 liquid feed device (liquid supply device)
37 confocal pinhole
43 motorized XYZ-θ stage (movable stage)
57 motorized correction ring (spherical aberration adjustment mechanism)
S sample (specimen)
W1 cuvette solution (first liquid medium)
W2 chamber solution (second liquid medium)
W3 immersion solution (third liquid medium)

1. A microscope comprising:
a medium container that holds a second liquid medium in which a specimen container, which contains a specimen together with a first liquid medium, is immersed;
an immersion objective lens that is disposed outside the medium container and that collects light coming from the specimen;
a detection optical system that detects the light collected by the immersion objective lens; and
a movable stage that supports the specimen container so as to be movable inside the medium container in at least a direction parallel to an optical axis of the immersion objective lens,
wherein the specimen container and the medium container each have a transparent portion that allows transmission of the light from the specimen, and
the immersion objective lens is disposed facing the transparent portion in the specimen container, with the transparent portion of the medium container interposed therebetween, and is disposed so that a third liquid medium is interposed between said immersion objective lens and the transparent portion of the medium container.

2. A microscope according to claim 1, further comprising a liquid supply device that supplies the third liquid medium between the transparent portion of the medium container and the immersion objective lens.

3. A microscope according to claim 1, wherein the immersion objective lens is disposed facing the optical axis in a direction intersecting a vertical direction, and
the third liquid medium is held between the immersion objective lens and the transparent portion of the medium container by means of surface tension.

4. A microscope according to claim 3, wherein the specimen container and the medium container have the transparent portions in respective side walls thereof, and
the immersion objective lens is disposed facing the optical axis in a direction substantially perpendicular to the vertical direction.

5. A microscope according to claim 1, wherein the immersion objective lens is supported so as to be movable in a direction parallel to the optical axis.

6. A microscope according to claim 1, wherein the first liquid medium and the second liquid medium have substantially the same refractive indexes as each other.

7. A microscope according to claim 1, wherein the third liquid medium has substantially the same refractive index as the second liquid medium.

8. A microscope according to claim 1, wherein the detection optical system includes a spherical-aberration adjustment mechanism that adjusts spherical aberration.

9. A microscope according to claim 8, further comprising a control unit that controls the spherical-aberration adjustment mechanism according to the movement of the movable stage to correct the spherical aberration.

10. A microscope according to claim 1, further comprising a lens switching part that switches the immersion objective lens to another immersion objective lens having a different magnification.

11. A microscope according to claim 1, further comprising:
a confocal pinhole that is disposed at a position conjugate with a focal position of the immersion objective lens and that partially allows fluorescence coming from the specimen and collected by the immersion objective lens to pass therethrough,
wherein the detection optical system irradiates the specimen with excitation light emitted from a light source and detects the fluorescence that is produced in the specimen irradiated with the excitation light and that is passes through the confocal pinhole.

12. A microscope according to claim 1 wherein:
the immersion objective lens irradiates the specimen with ultrashort-pulse laser light emitted from a light source and collects fluorescence produced in the specimen as a result of a multiphoton excitation effect due to being irradiated with the ultrashort-pulse laser light; and
the detection optical system detects the fluorescence collected by the immersion objective lens.
